(19) United States
(12) Patent Application Publication
(10) Pub. No.: US 2008/0001986 A1
(43) Pub. Date: Jan. 3, 2008

(54) Droplet discharging device and ink jet printer

(75) Inventor: Takaichiro Umeda, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 11/824,118

(22) Filed: Jun. 29, 2007

(30) Foreign Application Priority Data
Jun. 30, 2006 (JP) 2006-181775

(51) Int. Cl. B41J 2/165

(52) U.S. Cl. 347/29

(57) ABSTRACT

A droplet discharging device is provided with a discharging head, a first cap, a second cap and a barometric pressure controlling device. The discharging head has a first discharging opening and a second discharging opening. The second discharging opening is smaller than the first discharging opening. The first cap is capable of making contact with the discharging head and covering the first discharging opening. The second cap is capable of making contact with the discharging head and covering the second discharging opening. The barometric pressure controlling device controls a first barometric pressure within the first cap making contact with the discharging head and a second barometric pressure within the second cap making contact with the discharging head such that the second barometric pressure is greater than the first barometric pressure.

### CROSS-REFERENCE TO RELATED APPLICATION

This application claims priority to Japanese Patent Application No. 2006-181775, filed on Jun. 30, 2006, the contents of which are hereby incorporated by reference into the present application.

### BACKGROUND OF THE INVENTION

1. Field of the Invention

The present invention relates to a droplet discharging device that discharges liquid in the form of droplets. Furthermore, the present invention relates to an ink jet printer utilizing this droplet discharging device.

2. Description of the Related Art

A droplet discharging device utilized in an ink jet printer or the like comprises a discharging head. The discharging head comprises a pressing device and a discharging opening. The pressing device applies pressure to a liquid such as ink or the like within the discharging head by means of, for example, deforming a piezoelectric element, changing the volume of a bubble by means of a thermal resistor, etc. The liquid to which pressure has been applied is discharged from the discharging opening. In the droplet discharging device, the liquid forms a meniscus in the discharging opening during an inactive state in which the liquid is not being discharged. The meniscus prevents the ink from leaking out from the discharging opening during the inactive state. If the inactive state continues for a long time, the water in the liquid of the meniscus evaporates. The meniscus becomes viscous when the water evaporates, and the viscous meniscus can then block the discharging opening. There is consequently a deterioration of the discharging characteristics of the droplet discharging device. In order to avoid the above problem, the droplet discharging device may include a cap that covers the discharging opening during the inactive state. The cap makes contact with the discharging head in an airtight manner by being pressed onto the discharging head. It is possible to prevent the evaporation of the water in the liquid of the meniscus by covering the discharging opening with the cap. Barometric pressure within the cap must be adjusted such that the meniscus does not break down.

### BRIEF SUMMARY OF THE INVENTION

The opening area of the discharging opening of the droplet discharging device is determined on the basis of its intended use. For example, in an ink jet printer capable of color printing, the opening area of the discharging opening for black ink is made as large as possible in order to increase printing speed. By contrast, the opening area of the discharging openings for color ink is smaller than the opening area for black ink in order to improve the image quality of color printing. The droplets that are discharged can be atomized by making the discharging opening for color ink small. By changing the opening area of the discharging openings of the droplet discharging device in the printer, it is possible to both increase the printing speed of monochrome printing and improve the image quality of color printing.

The breakdown stress of the meniscus formed in the discharging opening varies according to the opening area of the discharging opening. That is, as the opening area of a discharging opening becomes larger, the breakdown stress of a meniscus reduces. As a result, in a droplet discharging device that has discharging openings of differing opening areas, the barometric pressure within the cap must be determined so as to match the breakdown stress of the meniscus formed in the discharging opening that has the larger opening area.

And now, discharging openings that have small opening areas become blocked more readily than discharging openings that have large opening areas because the liquid near the discharging opening dries out.

The present invention has taken the above problem into consideration, and aims to suppress the blockage of discharging openings in a droplet discharging device that has discharging openings with differing opening areas.

A droplet discharging device taught in the present specification includes a discharging head, a first cap, a second cap, and a barometric pressure controlling device. The discharging head includes a first discharging opening and a second discharging opening. These openings discharge droplets. The second discharging opening is smaller than the first discharging opening. The first cap is capable of making contact with the discharging head and covering the first discharging opening. The second cap is capable of making contact with the discharging head and covering the second discharging opening. The barometric pressure controlling device controls a first barometric pressure within the first cap making contact with the discharging head and a second barometric pressure within the second cap making contact with the discharging head such that the second barometric pressure is greater than the first barometric pressure.

With this droplet discharging device, the barometric pressure within the cap covering the second discharging opening can be set to be a value within a range in which the breakdown stress of the meniscus formed in the second discharging opening is not exceeded. The barometric pressure within the cap covering the first discharging opening can be set to be a value within a range in which the breakdown stress of the meniscus formed in the first discharging opening is not exceeded. In this droplet discharging device, the meniscus formed in the first discharging opening is not damaged, and it is possible to suppress the drying out of the liquid near the second discharging opening having a small opening area. As a result, it is possible to suppress the blockage of the second discharging opening having a small opening area.

### BRIEF DESCRIPTION OF THE DRAWINGS

FIG. 1 shows an external perspective view of a multi function device of a first embodiment.

FIG. 2 shows a side surface view of the multi function device of the first embodiment.

FIG. 3 shows a schematic view of a printer part of the multi function device of the first embodiment.

FIG. 4 is a view from an upper surface side of an ink refill unit, an image recording part, etc. of the printer part of the first embodiment.

FIG. 5 is a view of the discharging openings that discharge ink droplets from a recording head of the first embodiment.

FIG. 6 shows a front view of a droplet discharging device of the multi function device of the first embodiment.

FIG. 7 shows a front view of a droplet discharging device of a multi function device of a second embodiment.

### DETAILED DESCRIPTION OF THE INVENTION

### First Embodiment

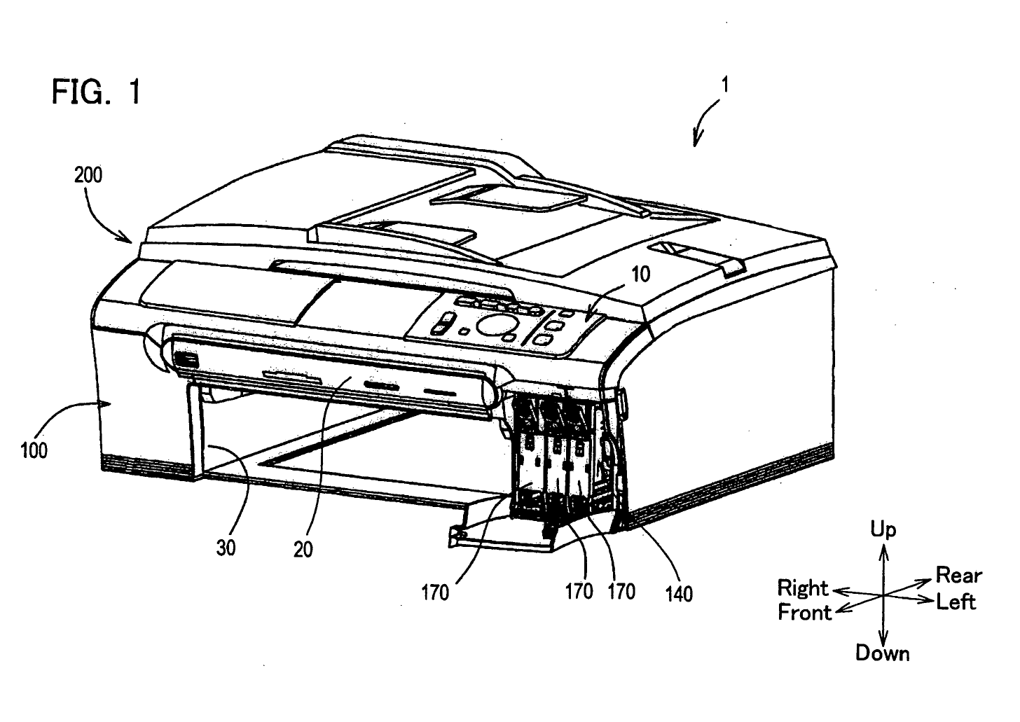

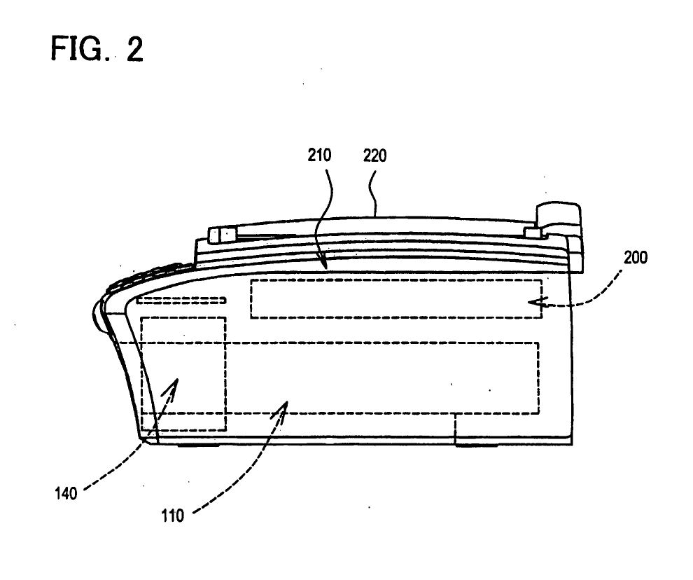

A multi function device including a droplet discharging device of a first embodiment will be described below with reference to the figures. FIG. 1 shows an external perspective view of the multi function device of the first embodiment. FIG. 2 shows a side surface view of the multi function device 1. The portion surrounded by the broken line in FIG. 2 shows devices and equipment housed within the multi function device 1. In the present embodiment, the droplet discharging device and an ink jet recording device are suitable for a multi function device provided with a scanner function, a copy function, a facsimile function, etc.

Furthermore, the multi function device 1 of the present embodiment is capable of being connected to a computer. The multi function device 1 is capable, on the basis of image data or document data transmitted from the computer, of recording image data that includes letters on a recording medium (hereafter termed recording paper) consisting of recording paper, a resin sheet, etc. Furthermore, the multi function device 1 is capable of being connected with an external device such as a digital camera, etc., and recording image data output from the digital camera onto the recording paper.

As shown in FIG. 1, the multi function device 1 includes a printer part 100 and a scanner part 200. The scanner part 200 is disposed at an upper section of the multi function device 1. The scanner part 200 reads an image from a document set on the scanner 200. As shown in FIG. 2, the scanner 200 includes an FBS (Flatbed Scanner) function for reading a document mounted on a document mounting part 210, and an ADF (Auto Document Feeder) 220.

Furthermore, as shown in FIG. 1, an operation panel 10, a slot part 20, and an insertion opening 30 are formed in a front surface side of the multi function device 1. The operation panel 10 is disposed in an oblique surface formed at an upper part of the front surface side of the multi function device 1. The operation panel 10 is connected to a controlling device (not shown). A user can operate the printer part 100 or the scanner part 200 by operating the operation panel 10. The slot part 20 is disposed at a lower side of the operation panel 10. A recording medium such as a memory card, etc. can be inserted into the slot part 20. The insertion opening 30 is disposed at a lower side of the slot part 20. A feeder tray 121 (to be described) is inserted into the insertion opening 30.

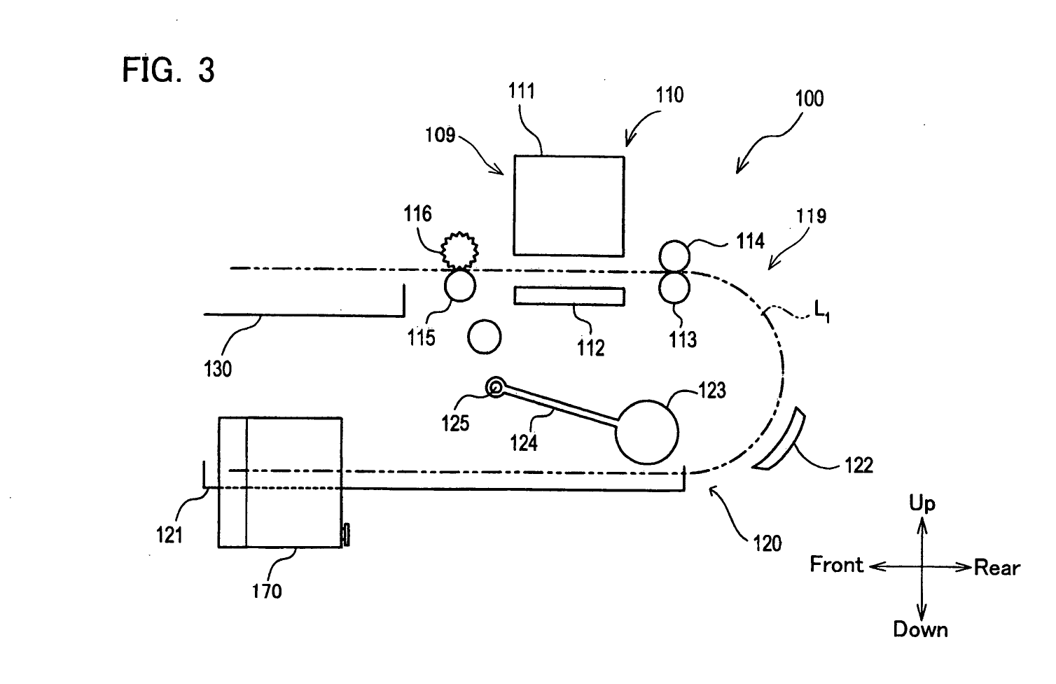

Next, the printer part 100 of the multi function device 1 will be described with reference to the figures. As shown in FIG. 1, the printer part 100 is disposed below the scanner part 200. FIG. 3 is a schematic view of the printer part 100.

As shown in FIG. 3, the printer part 100 includes an image recording part 110, a feeder part 120, an ink refill unit 140, etc. The image recording part 110 forms images on the recording paper. The feeder part 120 feeds the recording paper into the image recording part 110. The ink refill unit 140 transfers ink into the image recording part 110.

As shown in FIG. 3, the feeder part 120 includes the feeder tray 121, a separating oblique plate 122, and a feeder roller 123. A plurality of sheets of recording paper is mounted in the feeder tray 121. The feeder tray 121 is set within the multi function device 1 by being inserted into the insertion opening 30. The feeder roller 123 is disposed above the feeder tray 121. The feeder roller 123 is joined to a motor (not shown) via a driving transmission mechanism (not shown). The feeder roller 123 is axially supported by the tip of a feeder arm 124. The feeder arm 124 is capable of rotating around a base end axis 125. The feeder roller 123 can be moved downward and upward, by rotating the feeder arm 124, so that it is able to move toward and away from the recording paper in the feeder tray 121. When the recording paper is not being fed, the feeder roller 123 is pressed upward by a feeder clutch, spring, or the like (not shown). The feeder roller 123 thus moves away from the recording paper in the feeder tray 121. When the recording paper is to be fed into the image recording part 110, the feeder arm 124 swings down, whereby the feeder roller 123 makes contact with the recording paper in the feeder tray 121. The recording paper is fed toward the separating oblique plate 122 by rotating the feeder roller 123 while it is making contact with the recording paper.

The separating oblique plate 122 is disposed to the rear (at the right side of the page) of the feeder tray 121. The separating oblique plate 122 separates the recording paper mounted in the feeder tray 121 and guides a sheet of recording paper upward. The sheet of recording paper that has been guided upward is transferred along a transferring path L1. The transferring path L1 extends upward, then bends toward the front side of the multi function device 1 (the left side of the FIG. 3), and extends from a rear side to a front side of the multi function device 1. The transferring path L1 passes through the image recording part 110 and extends into a paper discharge tray 130. The sheet of recording paper that has been fed from the feeder tray 121 is guided so as to make a U-turn from a lower section of the printer part 100 to an upper section, and then reaches the image recording part 110. The sheet of recording paper that has had an image recorded thereon by the image recording part 110 (to be described) is discharged to the paper discharge tray 130.

Next, the image recording part 110 will be described with reference to the figures. The image recording part 110 is disposed at the downstream side of the separating oblique plate 122. As shown in FIG. 3, the image recording part 110 includes an ink discharging device 109 and a transferring device 119.

The transferring device 119 includes a platen 112, a driving roller 113, a pressing roller 114, a paper discharging roller 115, and a pressing roller 116. The driving roller 113 is rotated by an electric motor (not shown). The electric motor is controlled by a controlling device (not shown). The sheet of recording paper that is being transferred along the transferring path L1 makes contact with the driving roller 113 after passing over the separating oblique plate 122. The sheet of recording paper is transferred above the platen 112 by the rotation of the driving roller 113. The pressing roller 114 presses the sheet of recording paper onto the driving roller 113 by pressing against this driving roller 113. The pressing roller 114 follows the rotation of the driving roller 113 as it is pressing the recording paper toward the driving roller 113. The paper discharging roller 115 and the pressing roller 116 are disposed at the downstream side, in the paper transferring direction, from the platen 112 (discharging head 111). The paper discharge roller 115 and the pressing roller 116 grip the recording paper that has been ejected from the platen 112. The paper discharging roller 115 and the pressing roller 116 transfer the sheet of recording paper that has been recorded upon to the paper discharge tray 130. The rotation of the paper discharging roller 115 is mechanically linked with (in synchrony with) the rotation of the driving roller 113. The pressing roller 116 follows the rotation of the discharging roller 115 as it is pressing the recording paper toward the discharging roller 115. The pressing roller 116 is pressed against the recording paper that has been recorded upon. A face of the pressing roller 116 that makes contact with the recording paper has a convex and concave spurred shape (a cog shape). As a result, the pressing roller 116 does not damage the image recorded onto the recording paper.

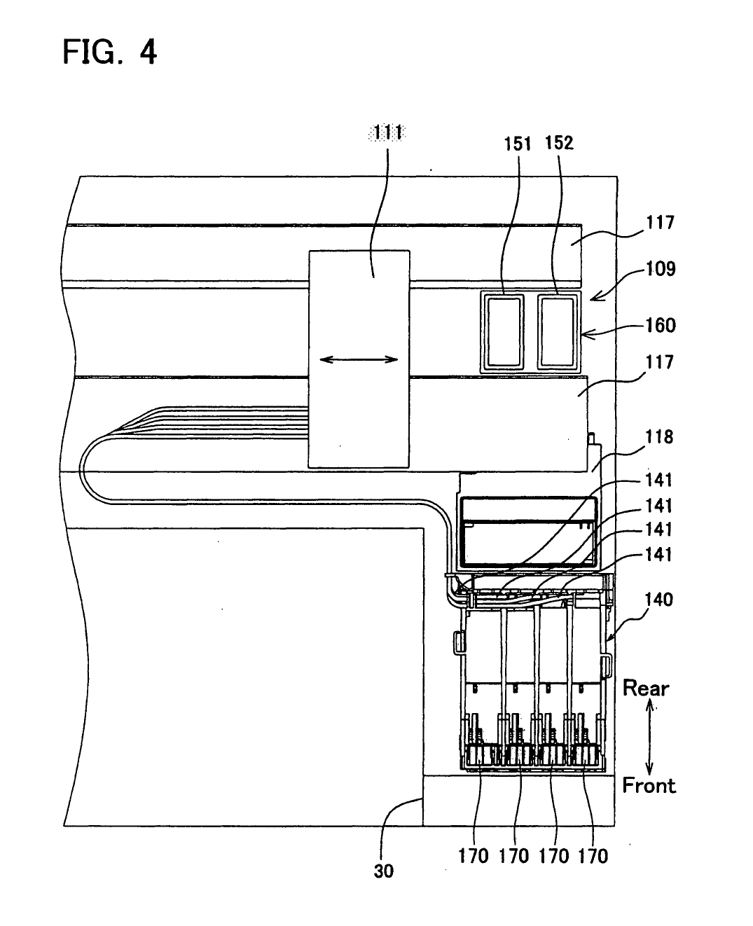

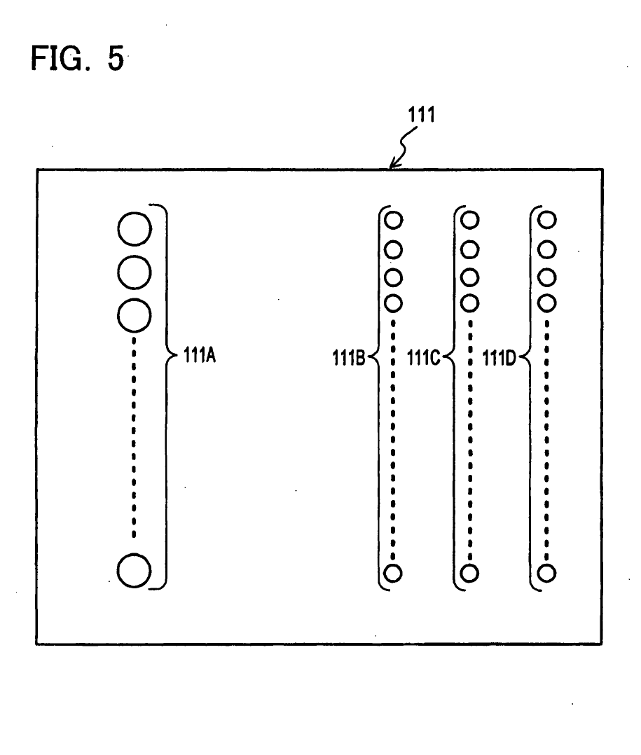

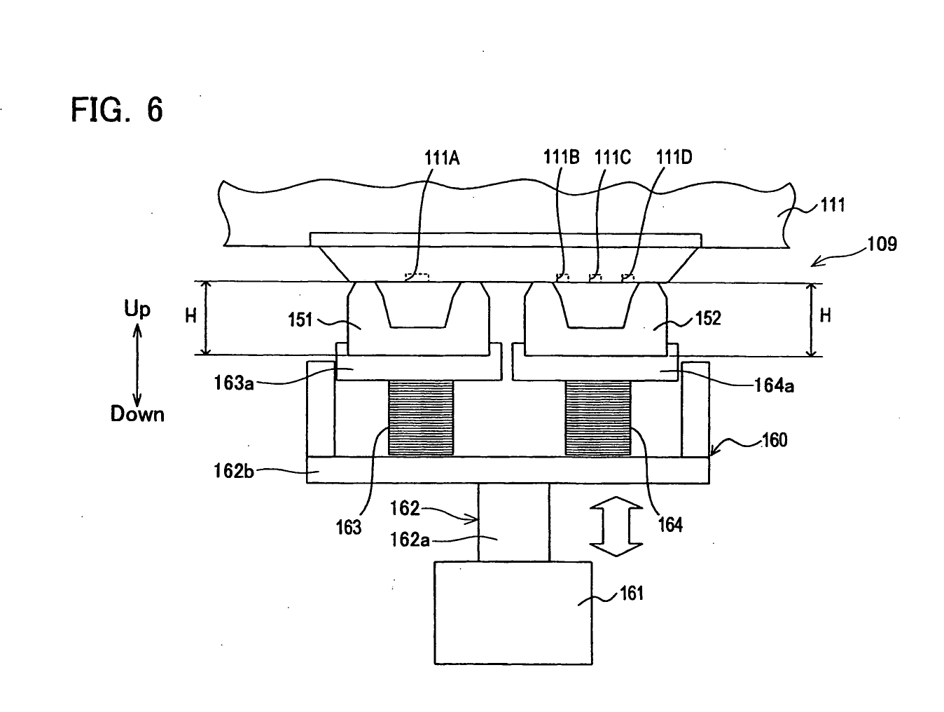

Next, the ink discharging device 109 will be described with reference to the figures. As shown in FIG. 3, the ink discharging device 109 is disposed above the platen 112. FIG. 4 is a view from an upper surface side of the ink refill unit 140, the image recording part 110, etc. FIG. 5 is a view from a discharging opening that discharges ink droplets from the recording head 111. FIG. 6 shows a front view of the ink discharging device 109. FIG. 6 shows a state in which a first cap 151 and a second cap 152 (to be described) are in a first position.

As shown in FIG. 4, the ink discharging device 109 includes the recording head 111, the first cap 151, the second cap 152, and an actuator 160. The recording head 111 is fixed to a carriage (not shown). The recording head 111 is supported so as to be capable of sliding along a rail member 117 via the carriage. The rail member 117 extends along a main scanning direction (the left-right direction) of the multi function device 1. As shown in FIG. 5, discharging openings 111A to 111D for discharging ink droplets are formed on a platen 112 side of the recording head 111. The discharging opening 111A is a discharging opening for discharging black ink. The discharging openings 111B to 111D are discharging openings for discharging color ink. The color ink is, for example, yellow, cyan, and magenta. Chiefly, ink consisting of dye is utilized for the color ink and ink consisting of pigment is utilized for the black ink.

The hole diameter of the discharging openings 111B to 111D for discharging the color ink that consists of dye such as cyan, magenta, yellow, etc. is smaller than the hole diameter of the discharging opening 111A for discharging the black, etc. ink that consists of pigment. The hole diameter of the discharging openings 111B to 111D for discharging the color ink is thus made extremely small, whereby the droplets that are discharged are atomized, thereby improving the image quality during color recording. By contrast, black ink is usually not utilized in color recording that requires a high image quality, and is mainly utilized in recording text data such as letters or the like. Consequently, in order to increase the printing speed, the hole diameter of the discharging opening 111A is larger than the hole diameter of the discharging openings 111B to 111D for discharging color ink. In the present embodiment, the hole diameter of the discharging opening 111A is approximately 0.02 mm. The hole diameter of the discharging openings 111B to 111D is approximately 0.015 to 0.018 mm. Below, the discharging opening 111A will be termed the first discharging opening 111A, and the discharging openings 111B to 111D will be collectively termed the second discharging opening 111B.

As shown in FIG. 4, the recording head 111 is connected to the ink refill unit 140 via ink tubes 141. The ink tubes 141 are formed from a bendable material such as polyethylene, etc. The ink refill unit 140 is capable of detachably housing four ink cartridges 170. Each ink cartridge 170 is filled with the sort of ink that corresponds to the discharge openings 111A to 111D. The ink that has been filled into the ink cartridges 170 is fed into the recording head 111 via the ink tubes 141.

As shown in FIG. 1 and FIG. 4, the ink refill unit 140 is disposed at the right side part of a front surface of the multi function device 1. Furthermore, as shown clearly in FIG. 3, the upper edges of the ink cartridges 170 are positioned lower than the first discharging opening 111A and the second discharging opening 111B. That is, upper surfaces of the ink liquid in the ink cartridges 170 are lower than the first discharging opening 111A and the second discharging opening 111B. Pressure caused by this difference in the fluid surface height is utilized to draw in the meniscuses that are formed in the first discharging opening 111A and the second discharging opening 111B.

As shown in FIG. 4, a discarded ink box 118 is disposed at a back surface side of the ink refill unit 140. The discarded ink box 118 stores discarded ink that is discharged during the purging process (recovery process) performed to remove foreign matter etc. from within the recording head 111. The purging process is performed while the first discharging opening 111A and the second discharging opening 111B are covered by the first cap 151 and the second cap 152 (to be described), and is performed by using a vacuum pump (not shown) to suck out air from within the first cap 151 and the second cap 152.

As shown in FIG. 4, the first cap 151 and the second cap 152 are disposed at one end (the discarded ink box 118 end) of the recording head 111 (carriage) in the main scanning direction. With the exception of the time while the purging process is being performed, the first cap 151 and the second cap 152 make contact with the platen 112 side of the recording head 111 and cover the discharging openings 111A to 111D when recording is not being performed (during the inactive state). The first cap 151 simultaneously covers a plurality of the first discharging openings 111A. The second cap 152 simultaneously covers a plurality of the second discharging openings 111B.

The first cap 151 and the second cap 152 are formed from an elastically deformable material such as butyl rubber, EPDM (Ethylene Propylene Diene Monomer), etc. The elastic coefficients of the first cap 151 and the second cap 152 are substantially identical. Furthermore, the first cap 151 and the second cap 152 have substantially identical exterior appearances. Here, the elastic coefficients of the first cap 151 and the second cap 152 being identical refer to the ratio of pressure being identical when the first cap 151 and the second cap 152 are pressed onto the recording head 111 as compared to the amount of change in height H (see FIG. 6) when the first cap 151 and the second cap 152 are pressed onto the recording head 111.

As shown in FIG. 6, the cap actuator 160 is disposed below the first cap 151 and the second cap 152. The cap actuator 160 is a lifter that moves the first cap 151 and the second cap 152 such that they switch between a first position where the first cap 151 and the second cap 152 make contact with the recording head 111 and a second position where they are separated from the recording head 111.

The cap actuator 160 includes an actuator main body 161, a holder part 162, spring parts 163 and 164, etc. The actuator main body 161 moves the holder part 162 in an up-down direction by driving the rotation of a cam (not shown). The holder part 162 has a shaft 162a and a spring supporting part 162b. The shaft 162a is disposed between the actuator main body 161 and the spring supporting part 162b. The shaft 162a transmits the driving force from the actuator main body 161 to the spring supporting part 162b. The bottom edges of the spring parts 163 and 164 are fixed to the top surface of the spring supporting part 162b. The spring parts 163 and 164 are coiled springs. The spring parts 163 and 164 may equally well be manufactured from, for example, an elastic material such as rubber, etc. rather than being a coiled spring. The elastic coefficient of the spring part 163 is set to be smaller than the elastic coefficient of the spring part 164. The first cap 151 is mounted on the top edge of the spring part 163 via a cap receiving part 163a. The second cap 152 is mounted on the top edge of the spring part 164 via a cap receiving part 164a. The actuator main body 161 drives the caps 151 and 152 in the up-down direction via the holder part 162 and the spring parts 163 and 164.

Next, the operation of the cap actuator 160 will be described. In the case where the printer part 100 is forming an image on the recording paper, the caps 151 and 152 are located in the second position. In the case where the purging process is performed while the image is being formed, the recording head 111 is moved to above the cap actuator 160. The cap actuator 160 is then driven, moving the caps 151 and 152 into the first position. The purging process is then performed.

When the printer part 100 has finished forming an image on the recording paper, or when a power supply switch (not shown) of the multi function device 1 is turned off, the recording head 111 is moved to above the cap actuator 160. The cap actuator 160 moves the holder part 162 toward the recording head 111. The caps 151 and 152 are thus moved into the first position. At this juncture, the first cap 151 is pressed toward the recording head 111 by the spring part 163. The second cap 152 is pressed toward the recording head 111 by the spring part 164. The elastic coefficient of the spring part 164 is greater than the elastic coefficient of the spring part 163. As a result, the pressure exerted when the second cap 152 is covering the second discharging openings 111B is greater than the pressure exerted when the first cap 151 is covering the first discharging openings 111A. Since the elastic coefficients of the first cap 151 and the second cap 152 are identical, the amount of deformation of the second cap 152 is greater than the amount of deformation of the first cap 151. As a result, the barometric pressure within the second cap 152 is greater than the barometric pressure within the first cap 151. In the ink discharging device 109, the barometric pressures within the first cap 151 and the second cap 152 are determined by the respective elastic coefficients of the spring part 163 and the spring part 164. Here, the greater the opening area of the discharging openings, the smaller the breakdown stress of the meniscuses formed in the discharging openings. It is known that, in the case where the discharging openings are circular, the breakdown stress of the meniscuses becomes smaller in inverse proportion to an increase in the radius. As a result, for example, in the ink discharging device 109, the ratio of the elastic coefficients of the spring part 163 and the spring part 164 may be set to be in inverse proportion to the ratio of the radius of the first discharging openings 111A and the second discharging openings 111B.

The holder part 162 has ample rigidity compared to the caps 151 and 152 and the spring parts 163 and 164. As a result, even when the cap actuator 160 presses the first cap 151 and the second cap 152 onto the recording head 111, the amount of deformation of the holder part 162 is almost imperceptible compared to the amount of deformation of the first cap 151 and the second cap 152 and the spring parts 163 and 164.

When the image forming operation (the recording operation) is being performed by the printer part 100, the cap actuator 160 moves the holder part 162 away from the recording head 111. The first cap 151 and the second cap 152 are thus moved into the second position. The first discharging openings 111A and the second discharging openings 111B are thus opened to the air.

The amount of water evaporation from the discharging openings 111A and 111B per unit time is not greatly affected by the size of the opening area of the discharging openings 111A and 111B but varies according to the tightness of the cap and the barometric pressure exerted on the meniscus. That is, the smaller the degree of tightness, the greater the amount of evaporation. Furthermore, the lower the barometric pressure exerted on the meniscus, the greater the amount of evaporation. In the case where the pressing load exerted by the caps 151 and 152 is the same, the degree of tightness and the barometric pressure exerted on the meniscus by the caps 151 and 152 is the same. In this case, substantially the same amount of water evaporates from the discharging openings 111A and 111B. However, the amount of ink stored near the second discharging openings 111B that have a small opening area is less than the amount of ink stored near the first discharging openings 111A that have a large opening area. As a result, the ratio of water evaporation, as a proportion of the amount of ink in the opening, is greater for the second discharging openings 111B that have a small opening area compared to the first discharging openings 111A that have a large opening area. As a result, the ink stored near the second discharging openings 111B that have small opening areas dries up more readily and the viscosity thereof increases more readily than the ink stored near the first discharging openings 111A that have large opening areas. Therefore, if the pressing load exerted by the caps 151 and 152 is the same, the second discharging openings 111B that have a small opening area will easily become blocked.

In the present embodiment, when the first discharging openings 111A are covered by the first cap 151, the barometric pressure within the first cap 151 is smaller than the barometric pressure within the second cap 152 when the second discharging openings 111B are covered by the second cap 152. As a result, the barometric pressure within the first cap makes it possible to prevent damage to the meniscus formed in the first discharging openings 111A which have large opening areas, and it is possible to suppress the evaporation of water from the ink near the second discharging openings 111B.

Furthermore, the pressure exerted when covering the second discharging openings 111B that have a small opening area is greater than the pressure exerted when covering the first discharging openings 111A which have a large opening area. As a result, it is possible to increase tightness (the seal) when the second discharging openings 111B are covered. It is thus possible, with a recording head 111 that has discharging openings that have different opening areas, to suppress the blockage of the discharging openings having a small opening area caused by the ink therein drying out.

Furthermore, the spring parts 163 and 164 are disposed between the first cap 151 and the second cap 152 and the spring supporting part 162b. As a result, these spring parts 163 and 164 compensate for any difference in the dimensions of the first and second caps 151 and 152, the actuator main body 161, and the recording head 111. It is consequently possible to reduce the effect that any inaccuracy in dimensions has upon the tightness of the caps 151 and 152 with the recording head 111. Furthermore, it is possible to press the caps 151 and 152 onto the recording head 111 with a suitable pressure by adjusting the elastic coefficient of the spring parts 163 and 164.

### Second Embodiment

In the first embodiment, the first cap 151 and the second cap 152 are moved by the single actuator 160. However, an actuator may be provided for each cap.

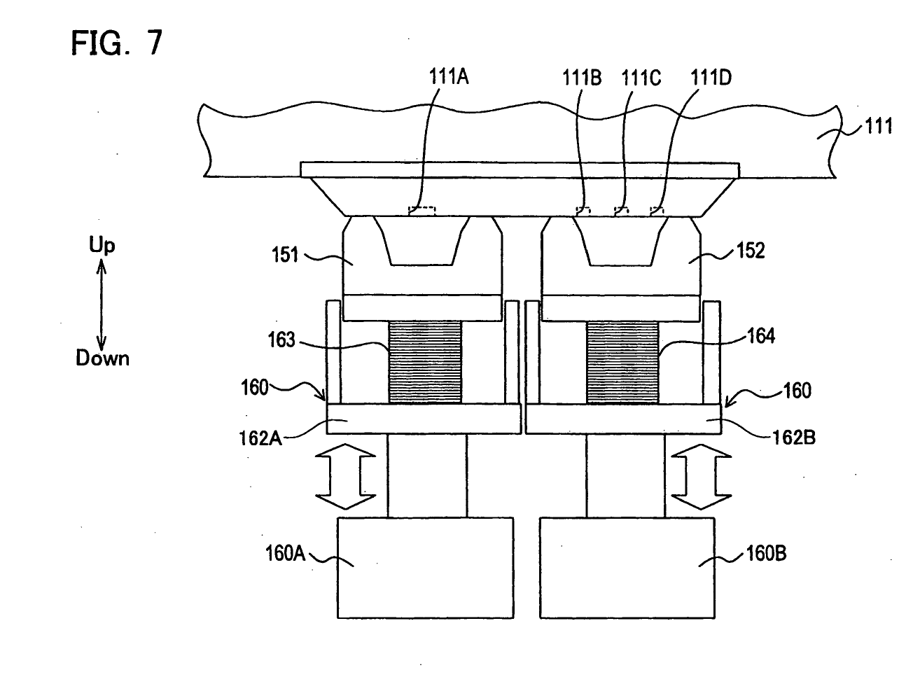

The configuration of an actuator of the second embodiment will be described with reference to FIG. 7. With the exception of the actuator, the multi function device of the second embodiment is the same as the multi function device of the first embodiment. Hereinafter, only the actuator will be described. FIG. 7 shows a front view of an ink discharging device 109 of the multi function device 1 of the present embodiment. FIG. 7 shows a state where the first cap 151 and the second cap 152 are in the first position. As shown in FIG. 7, a first actuator 160A for the first cap 151, and a second actuator 160B for the second cap 152 are provided. The spring part 163 is disposed between the first cap 151 and the first actuator 160A. The spring part 163 is supported by a first spring supporting part 162A. The spring part 164 is disposed between the second cap 152 and the second actuator 160B. The spring part 164 is supported by a second spring supporting part 162B.

The amount of movement of the actuators 160A and 160B is controlled independently. For example, the elastic coefficient of the spring parts 163 and 164 may be identical and the natural length of the spring parts 163 and 164 may be identical. In this case, the distance between the second cap 152 and the second spring supporting part 162B may be smaller than the distance between the first cap 151 and the first spring supporting part 162A at the first position. That is, the amount of deformation of the spring part 164 may be greater than the amount of deformation of the spring part 163. The pressure applied by the second cap 152 will be greater than the pressure applied by the first cap 151. The amount of deformation of the second cap 152 will be greater than the amount of deformation of the first cap 151. As a result, the barometric pressure within the second cap 152 can be made greater than the barometric pressure within the first cap 151. In the second embodiment, the pressure of the first cap 151 and the second cap 152 can be determined for each cap by moving the cap actuators 160A and 160B. For example, the ratio of the amount of movement of the cap actuator 160A and the cap actuator 160B may be set to be in inverse proportion to the ratio of the radius of the first discharging openings 111A and the second discharging openings 111B. With the configuration of the second embodiment, as well, it is possible to reduce the potential for blockages of the discharging openings that have a small opening area caused by the ink therein drying out, while simultaneously preventing damage to the meniscus formed in the discharging openings that have a large opening area.

### Other Embodiments

In the above embodiments, the spring parts 163 and 164 are disposed between the first cap 151 and the second cap 152. However, the present invention is not restricted to this configuration, and the spring parts 163 and 164 may be absent. In this case, the first cap 151 may be connected to the spring supporting part by a first shaft and the second cap 152 may be connected to the spring supporting part by a second shaft. In the first embodiment, in order to adjust the barometric pressure within the first cap 151 and the second cap 152, the second shaft may be longer than the first shaft. In the second embodiment, the length of the first shaft and the second shaft may be identical and the distance between the second cap 152 and the second spring supporting part 162B may be smaller than the distance between the first cap 151 and the first spring supporting part 162A at the first position.

In the above embodiments, the elastic coefficients of the first cap 151 and the second cap 152 are substantially identical. However, the present invention is not restricted to this configuration, and the elastic coefficient of the first cap 151 may be smaller than the elastic coefficient of the second cap 152, and the pressure applied by the first cap 151 may be smaller than the pressure applied by the second cap 152. Furthermore, the first cap 151 and the second cap 152 may have difference exterior appearances. The first cap 151 may be made from a material that is different to that of the second cap 152. In these cases, the barometric pressure within the second cap 152 may be made greater than the barometric pressure within the first cap 151 by adjusting the elastic coefficient of the spring parts 163 and 164 or the amount of movement of the first and second cap actuators 162A and 162B.

In the above embodiments, an actuator is provided that moves the first cap 151 and the second cap 152 between the first position and the second position. However, the first cap 151 and the second cap 152 may function equally well by not moving. In this case, the recording head 111 may move with respect to the first and second caps 151 and 152.

In the above embodiments, the ink jet recording device of the present invention is applied to a multi function device that has a printer function, scanner function, copy function, facsimile function, etc. However, the present invention is not restricted to being applied thereto.

Furthermore, in the above embodiments, the discharging openings 111B to 111D for discharging cyan, magenta, and yellow ink are covered by the single second cap 152. However, the present invention is not restricted to this configuration, and the discharging openings 111B to 111D may each be provided with caps.

It is preferred that, by making the basic composition of the inks identical, properties such as viscosity etc. are made uniform for the plurality of types of ink discharged from the ink discharging device 109, thereby ensuring that controlling the discharging driving for the ink discharging device 109 is simple. If the basic compositions of the inks are identical, and the properties of the inks are identical, the breakdown stress of the ink meniscuses in the discharging openings is substantially determined by the opening area of the discharging openings. In this case, it is possible to set the barometric pressure within the caps (for example, the pressure with respect to the caps, etc.) based on the size of the opening area. In a case where the properties of the ink differ (for example, in the case where the amount or type of a surfactant differs), the surface tension of the inks differs. In this case, the breakdown stress of the ink meniscuses may differ even when the opening area of each discharge openings is the same. In this case, it is preferred that the barometric pressure (or pressure) within the caps is set, such that the meniscus formed in the discharging openings does not break down, by covering the discharging openings with separate caps, thus accommodating variations in both the opening area of the discharging openings and the properties of the ink.

Furthermore, in the above embodiments, the droplet discharging device of the present invention is applied to an ink jet printer. However, the present invention is not restricted to being applied thereto. Furthermore, the present invention may conform to the aims of the invention set forth in the claim, and is not limited to the specific examples described above.

What is claimed is:

1. A droplet discharging device, comprising:
a discharging head comprising a first discharging opening and a second discharging opening, wherein the second discharging opening is smaller than the first discharging opening;
a first cap capable of making contact with the discharging head and covering the first discharging opening;
a second cap capable of making contact with the discharging head and covering the second discharging opening;
a barometric pressure controlling device that controls a first barometric pressure within the first cap making contact with the discharging head and a second barometric pressure within the second cap making contact with the discharging head such that the second barometric pressure is greater than the first barometric pressure.

2. The droplet discharging device as in claim 1, wherein
the first cap is elastically deformable,
the second cap is elastically deformable, and
the barometric pressure controlling device controls the first barometric pressure and the second barometric pressure by elastically deforming the first cap and the second cap.

3. The droplet discharging device as in claim 2, wherein
the barometric pressure controlling device comprises a main body, a first spring located between the main body and the first cap making contact with the discharging head, and a second spring located between the main body and the second cap making contact with the discharging head, and
an elastic coefficient of the second spring is greater than an elastic coefficient of the first spring.

4. The droplet discharging device as in claim 3, wherein
the barometric pressure controlling device further comprises an actuator that moves the main body between a first position and a second position,
in the first position, the first cap and the second cap make contact with the discharging head, and
in the second position, the first cap and the second cap are positioned away from the discharging head.

5. The droplet discharging device as in claim 2, wherein
the barometric pressure controlling device comprises a first main body, a first spring located between the first main body and the first cap making contact with the discharging head, a second main body, and a second spring located between the second main body and the second cap making contact with the discharging head, and
in a state where the first cap and the second cap are making contact with the discharging head, a distance between the second main body and the discharging head is less than a distance between the first main body and the discharging head.

6. The droplet discharging device as in claim 5, wherein
an elastic coefficient of the second spring is equal to an elastic coefficient of the first spring.

7. The droplet discharging device as in claim 1, wherein
an exterior appearance and a material of the first cap are identical to those of the second cap.

8. The droplet discharging device as in claim 1, wherein
the first discharging opening is an opening for discharging ink droplets including pigments, and
the second discharging opening is an opening for discharging ink droplets including dyes.

9. The droplet discharging device as in claim 1, wherein
the first discharging opening is an opening for discharging black ink droplets, and
the second discharging opening is an opening for discharging color ink droplets.

10. An ink jet printer, comprising:
the droplet discharging device as in claim 1, wherein the droplet discharging device discharges an ink droplet.

11. A droplet discharging device, comprising:
a discharging head comprising a first discharging opening and a second discharging opening, wherein the second discharging opening is smaller than the first discharging opening;
a first cap capable of making contact with the discharging head and covering the first discharging opening, wherein the first cap is elastically deformable;
a second cap capable of making contact with the discharging head and covering the second discharging opening, wherein the second cap is elastically deformable;
a pressing device that presses the first cap and the second cap against the discharging head such that a pressure against the second cap is greater than a pressure against the first cap.

12. A droplet discharging device, comprising:
a discharging head comprising a first discharging opening and a second discharging opening, wherein the second discharging opening is smaller than the first discharging opening;
a first cap capable of making contact with the discharging head and covering the first discharging opening, wherein the first cap is elastically deformable;
a second cap capable of making contact with the discharging head and covering the second discharging opening, wherein the second cap is elastically deformable;
a pressing device that presses the first cap and the second cap against the discharging head such that an amount of deformation of the second cap is greater than an amount of deformation amount of the first cap.
